(19) United States
(12) Patent Application Publication
(10) Pub. No.: US 2003/0217266 A1
(43) Pub. Date: Nov. 20, 2003

(54) Collaboration of resources in a distributed environment using credentials and encryption keys

(76) Inventors: Edward C. Epp, Portland, OR (US); Steve Dohrmann, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/146,844

(22) Filed: May 15, 2002

(51) Int. Cl. H04L 9/00

(52) U.S. Cl. 713/163; 380/277

(57) ABSTRACT

A collaboration of resources in a distributed environment using credentials and encryption keys is described. According to one embodiment of the invention, a first resource entity receives a communication from a second resource entity over a network. The communication is decrypted with a secret and includes a set of one or more credential and a contact identifier of the second resource entity. The second resource entity is allowed to access a resource on the first resource entity based on the one or more credentials associated with the contact identifier.

### BACKGROUND

1. Field on the Invention

An embodiment of the invention relates to the field of network computing, and more specifically to the collaboration of resources in a distributed environment using credentials and encryption keys.

2. Background

Collaboration software applications, such as, chat room software, allow for a group of users with a shared interest to communicate. These software applications may be adequate for unsecured, social type chat rooms. However, privacy and trust are important features of the software when the group is brought together in the context of a business transaction. The risks of communicating with some collaboration software include the capture, spoofing, and retransmission of private information. In a business context, it is important to protect the integrity and privacy of critical electronic information and restrict what untrustworthy, non-members to the group may do with the information.

Some software products try to instill trust by creating a buddy list or an electronic address book of those acquaintances that they trust. However, these software applications do not have the capability to verify identity, differentiate trust between the various members of the group or have an acquaintance be a member of multiple groups. For instance, an attorney may communicate with a group of individuals for the purpose of developing a litigation strategy for a specific client. In such a situation, using collaboration software, the attorney may inadvertently send a communication to a trusted member of one buddy list or electronic address book that is not the trusted member of the group developing the litigation strategy. In addition, the collaboration software does not have the capability to prevent specific collaboration group members from accessing specific resources, such as, as a legal document. Also, the collaboration software does not have the capability to prevent specific group members from inviting others to the group, thereby increasing the possibility of exposing of private information. Therefore, today's collaboration software applications do not provide the trust and security needed to facilitate the accomplishment of a collaborative goal.

### BRIEF DESCRIPTION OF THE DRAWINGS

The invention may best be understood by referring to the following description and accompanying drawings that are used to illustrate embodiments of the invention. In the drawings:

FIG. 1 illustrates a resource management distributed collaboration environment according to one embodiment of the invention;

FIG. 2 illustrates an object oriented entity relationship diagram of the relationship management architecture according to one embodiment of the invention;

FIG. 3 illustrates the addition of a new member to a collaboration group according to one embodiment of the invention;

FIG. 4 illustrates a flow diagram of a resource entity accepting an invitation to join a collaboration group, according to one embodiment of the invention;

FIG. 5 illustrates a flow diagram of the authentication of collaborative communications between members of a collaboration group according to one embodiment of the invention; and

FIG. 6 illustrates an exemplary processing system in which an embodiment of the invention may be implemented.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Collaboration of resources in a distributed environment using credentials and encryption keys is described. Specifically, a resource management software component is associated with collaboration software to provide trusted communications, between members of one or more collaboration groups with the exchange of credentials with symmetrical and public encryption keys used for identification. The exchanged credentials describe the roles and responsibilities that each group member in a specific collaboration group may perform.

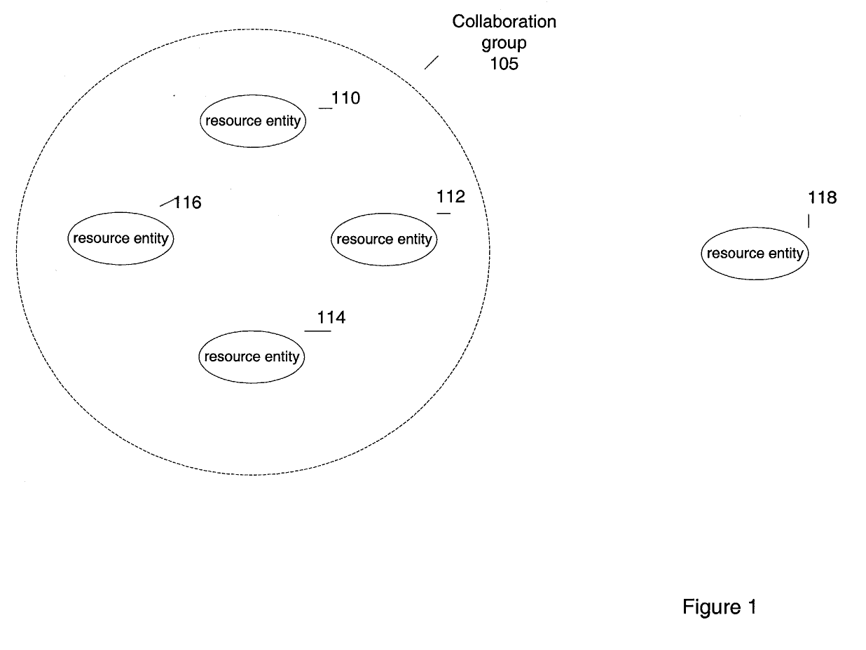

FIG. 1 illustrates a resource management distributed collaboration environment according to one embodiment of the invention. The resource management distributed collaboration environment includes resource entities 110, 112, 114, 116, and 118. Each resource entity includes software that allows each resource entity to communicate and share information via audio, video, and/or text messaging applications (e.g., peer-to-peer applications, etc). Each resource entity also includes a relationship management software component that securely manages the identities and relationships between collaborative resources of a collaboration group. Collaboration resources encompass any entity that enhances the accomplishment of some tasks.

In FIG. 1, resource entities 110, 112, 114, and 116 collaborate as a collaboration group 105 (as depicted by the dashed circle) to accomplish a specific task. Although FIG. 1 illustrates the resource entities 110, 112, 114 and 116 as being a member of one collaboration group 105, in alterative embodiments each resource entity may be a member of multiple collaboration groups, each having separate electronic personas having various roles and responsibilities.

For example, the resource entities in the collaboration group 105 may represent a group collaborating to build a house. Here, resource entity 112 may represent the owner of the house, resource entity 110 may represent the architect, the resource entity 116 may represent the builder, and the resource entity 114 may represent the design plans. The resource management component is used to define relationships, and roles and responsibilities, such as, the architect 110 may modify the design plans 114, the builder 116 may modify the timetable of the design plans 114, and the owner 112 may approve all changes to the design plans 114, exclusively, or in combination, for example.

In one embodiment, the relationship management software is implemented using an object oriented programming language (e.g., Java, ActiveX, C++, among other examples). In this way, the relationship management software is designed with object-oriented classes and objects as is typical in object-oriented design. Although the relationships are described as inheriting the attributes of the associated classes based on the Java, ActiveX, C++, or other object oriented programming languages, it should be understood that other programming languages may also be used.

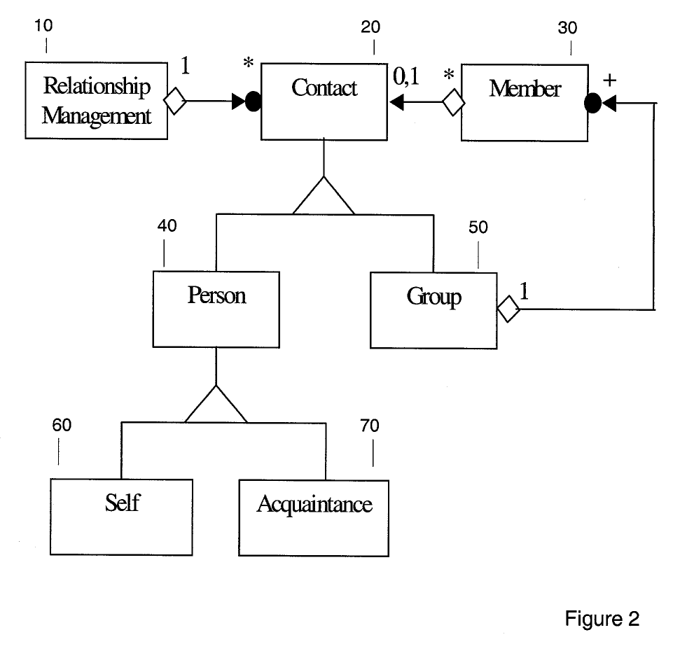

FIG. 2 illustrates an object oriented entity relationship diagram of the relationship management architecture according to one embodiment of the invention. FIG. 2 includes a relationship management class 10, a contact class 20, a member class 30, a person class 40, a group class 50, a self class 60, and an acquaintance class 70. One of the design benefits of such an object-oriented architecture is inheritance, where a resource management class may inherit the attributes of another resource management class. Inheritance in object-oriented programming is well known to those of ordinary skill in the art. FIG. 2, also illustrates the relationships of these classes organized in a composite object design pattern. This composite object design pattern provides substantial flexibility when other subclasses of the contact class 20 are later added, as will be described.

Each of the resource classes 10, 20, 30, 40, 50, 60, and 70 contains a set of zero or more attributes to define relationships between the resource entities. In one embodiment, attributes may name and/or characterize a resource. For example, in one embodiment, attributes are characteristics that specify what a resource entity can do and share within a collaboration group (e.g., they characterize roles and responsibilities of a resource entity), such as, the ability to invite another resource entity to the collaboration group, the ability to access information, among other examples.

The resource management class 10 contains zero or more contacts. Each contact class 20 is associated to one resource management class 10. For example, the resource management class 10 may represent a database or a middleware component.

The contact class 20 is an abstract representation of a resource entity used to specify a resource entity's roles and responsibilities. In one embodiment, the contact class 20 includes local attributes and peer attributes. Local attributes are user-defined attributes that are considered local to a particular resource management instance. The environment in which resource management finds itself will define which attributes are required. The local resource management instance is in charge of creating and manipulating the local attribute. Examples of local attributes include a history attribute, an advertisement attribute, and an authorization attribute, among other examples. The history attribute describes how a contact instance was formed, who created the contact instance, and how the contact instance was verified. The advertisement attribute is a characteristic that is used to describe a specific contact instance, such as, a local nickname, business card, and notes. The authorization (roles) attribute describes permissions given a local resource management instance and rules about how they can change. This may be implemented with certificates, which are well known to those of ordinary skill in the art.

The peer attribute is a collection of attributes that identify and locate other instances of contacts. It is the peer attributes, such as a contact identifier and an electronic address that are shared and synchronized between resource entities. A contact identifier is a characteristic that uniquely identifies a specific contact instance. In one embodiment, the contact identifier is the public portion of a public-private key pair as will be further described below. A contact electronic address is a characteristic by which a remote contact instance may be contacted. For example, the electronic address may be an electronic address suitable for transmission of a communication by General Packet Radio Service (GPRS), 802.11, and other well known communications protocols.

The triangle illustrated under the contact class 20 in FIG. 2 signifies the person class 40 and group class 50 inherits from the contact class 20. Therefore, the person class 40 inherits zero or more attributes from the contact class 20, and may represent traditional resources entities, such as, a business colleague, a friend, and a family member, among other examples. Although FIG. 2 illustrates the person class 40 inheriting from the contact class 20, in alternative embodiments, additional classes representing numerous resources may also be described. Therefore, the contact class 40 may represent other resource entities such as, a person, a business, a corporation, a computer, an air conditioner unit, a legal document, a technical journal, architecture design plans, etc.

Continuing the illustrated example of the person class 40, the following describes the inherit nature of a person. As shown, a person may be described or represented as a self class 60 or an acquaintance class 70. The triangle under the person class 40, illustrates that the self class 60 and the acquaintance class 70 both inherit from the person class 40. Therefore, a self class 60 inherits the attributes of the person class 40, and contact class 20 of the relationship management class 10.

In one embodiment, the self class 60 includes the attributes of an electronic persona of a local resource entity. In this way, each person may be represented to have multiple electronic personas. For example, in one instance, a resource entity of a type person might have an employee persona, a parent persona, a member of a softball team persona, or a persona of a member of a collaboration group whose purpose is to build a house.

The attributes of the self class 60 also includes one or more credentials that are a type of attribute that defines the roles and responsibilities of a specific resource entity. For instance, one or more credentials may represent what a specific resource management instance can perform and share with the other remote resource entities, among other examples. For example, the credentials for a specific person resource management instance may describe a permission to invite new members to join the group, edit a design plan, initiate a remote resource on another resource management device, among other examples. In this way, the credentials of the self class 60 defines the roles and responsibilities of each persona of a contact.

The acquaintance class 70 describes one or more electronic personas with which the specific self persona might interact (e.g., collaborating communications). The attributes of the acquaintance class 70 represent a set of one or more credentials describing what other remote resource entities can perform and what is known about them. In this way, a local resource entity instance may determine whether a remote resource entity is a member of the group, has permission to perform specific actions to the local resources, among other examples.

The group class 50 is a composite contact that contains a set of contact and group attributes. More specifically, the group class 50 includes data describing a group of resource entities and the definition for a group is recursive. Hence, group class 50 may be composed of multiple groups.

The member class 30 is an element of a group class 50. The member class 30 contains a single peer attribute that maps a member class 30 instance to a contact and its enclosing collaboration group. Each collaboration group has one or more members. In one embodiment, the member class 30 attributes include a member identifier, a member electronic address, and a group identifier. The member identifier and member electronic address store data similar to the contact identifier and contact electronic address attributes, as described above. The group identifier identifies the collaboration group the member instance is in. In one embodiment, the group identifier is the public portion of a public-private key pair used to identify the collaboration group 105.

In one embodiment, group and member attributes determine who can invite members into a collaboration group, what those members can do once they are members, and limit the number of members within the group, among other examples. Therefore, it should be understood that in this way attributes and credentials defining the roles and responsibilities of a specific resource management instance might be stored in one or more of the various classes, and are not limited to being stored only in the classes as described.

In addition, the attributes and the number of members can be used to categorize groups. For example, a collaboration communication may be characterized as one-way (e.g., a member may only receive messages and another may only send.), two-way (e.g., both members may receive and send messages), n-way (e.g., n members may receive and send a message), person-to-person (e.g., membership is limited to two members), public (e.g., contacts that are not members of the group can receive and send messages), symmetric (e.g., all member have equal authority), asymmetric (e.g., at least one member has different authority than some other member), among other examples. In this way, credentials are hierarchical in nature.

The group class also includes a secret key attribute. Each member of a collaboration group uses the secret key to communicate securely with the other members of the collaboration group. In one embodiment, the secret key may be a public key portion of a public-private key pair generated for the group. This may be the same public key as the group identifier, as described above. For example, when a member wants to communicate with another member of the collaboration group the communication would be encrypted with the private portion of the public-private key and the other member decrypts the communication with the public portion of the public-private key pair or viceversa.

In one embodiment, the secret key is a symmetrical encryption key. A symmetrical key system is one in which the sender and receiver of a communication share a single, common key, whereas the encryption key and the decryption key are the same and the encryption key can be calculated from the decryption key, and vice-versa. For example, in one embodiment, the well-known Diffie-Hellman encryption key system may be used. Once a symmetrical encryption key has been generated, it is shared with ever member of a collaboration group as the secret key. In this way, collaboration communications between collaboration group members are encrypted according to the specific group defined.

It should be understood that the secret key might comprise additional alternative techniques that are well known to those of ordinary skill in the art, but are not disclosed here in order to not obscure the description. These alternative techniques may also prevent a malicious program or person from reading or tampering with individual collaboration communications.

Accordingly, each resource management instance defines the characteristics of a resource entity based on the various attributes and credentials. As stated, each resource entity has a set of credentials describing what various resource entities are able to perform and share with other resource entities. In one embodiment, the set of credentials are configured for a new resource entity when it is added to the collaboration group.

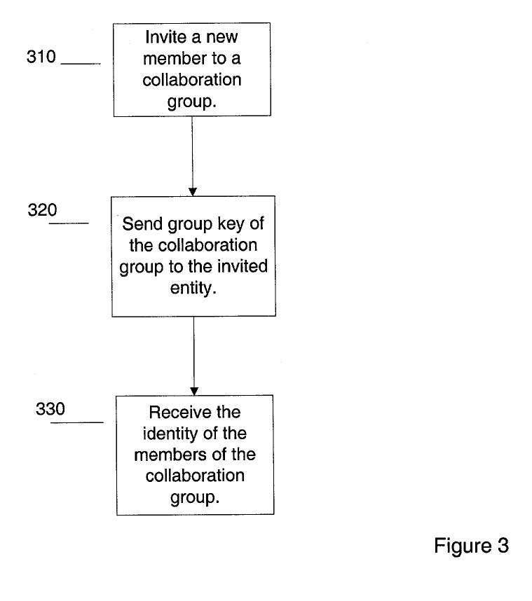

FIG. 3 illustrates the addition of a new member to a collaboration group according to one embodiment of the invention. At block 310, one of the collaboration group 105 members (resource entity 112) sends an invitation communication to a resource entity 118 to join the collaboration group 105. The invitation includes a set of one or more credentials. As stated, the credentials include a set of roles and responsibilities describing what permissions the newly added resource entity will have within the collaboration group 105. That is, the invite communication includes predefined attributes to be used as the resource management attributes of the new member. For example, the credential(s) may include permissions as to whether the invited resource entity 118 may invite other members to the collaboration group 105. In one embodiment, the invitation is an unencrypted message.

At block 320, upon receiving an acknowledgment that the resource entity 118 has received the invitation communication and would like to join the collaboration group 105, the resource entity 112 sends the resource entity 118 a secret key for the collaboration group. As stated, the secret key is used to secure collaborating communications between members of the collaboration group 105. For example, here the secret key may be a symmetrical key, where, upon receipt of the invitation reply, the resource entity 118 may begin a corresponding symmetrical key exchange process, that is well known to those of ordinary skill in the art.

At block 330, the contact identifier (e.g., public key identifier) of each member of the collaboration group 105 members (resource entity 110, 112, 114, 116) are transmitted to the new resource entity 118 member. In addition, the contact identifier of the new resource entity 118 is transmitted to each member of the collaboration group 105. Because the secret key has been exchanged, this synchronized communication can be performed securely.

It should be understood that once a resource entity has been added as a member of the collaboration group, each member can use the secret key to communicate privately with other members. In this way members of the collaboration group may collaborate to fulfill the objective of the group in a secure and trusted manner.

In one embodiment, one member of the group is designated as the collaboration group administrator. It is the group administrator that initially delegates authority and determines the role and responsibilities of each members of the group. However, it should be understood that in alternative embodiments there might be more than one group administrator in the collaboration group.

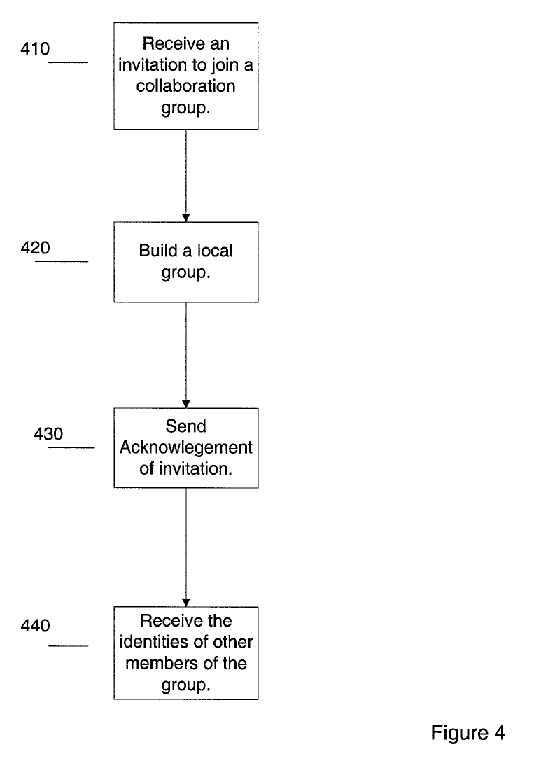

FIG. 4 illustrates a flow diagram of a resource entity accepting an invitation to join a collaboration group, according to one embodiment of the invention. At block 410, the resource entity 118 receives an invitation communication to join the collaboration group 105 (assuming, of course, the resource entity 118 is not yet a member of the collaboration group 105). The invitation includes a set of credentials.

At block 420, the resource entity 118 creates a local group. Adding a new group identifier to the group attribute creates the local group. In this way, the local group includes the new attributes and credentials received for the resource entity 118. For example, these credentials may define roles and responsibilities, such as, whether the resource entity 118 may invite additional members to the collaboration group 105.

At block 430, the resource entity 118 sends an acknowledgement of the invitation to the resource entity 112 of the collaboration group 105. In one embodiment, a two party key exchange procedure may begin as described above.

At block 440, the resource entity 118 receives the identity of the other members of the collaboration group 105. In one embodiment, a public key is received that uniquely identifies each resource entity member of the collaboration group 105. In one embodiment, each resource entity may store the unique identifiers of the other members of the collaboration group 105 as an attribute in the local instance of the acquaintance class 40.

In the context of a business transaction or a collaborative goal, trust between members of the collaboration group is ideal. Electronic representations of relationships between collaboration group members allow for the execution, management, and enforcement roles played between people, businesses, and other resources. As described, the credentials and attributes be used to determine who may access critical information (e.g., documents, calendar, email, credit information, bank accounts, etc.), who will know about the current state of a contact (e.g., at work, home, or on the road, etc.), and who will know how to contact a person (e.g., email or phone, etc.).

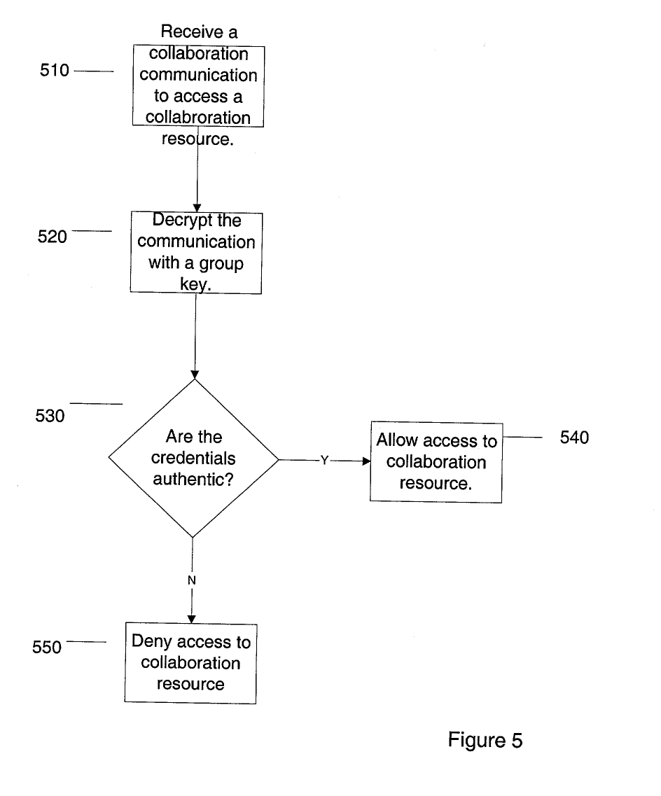

FIG. 5 illustrates a flow diagram of the authentication of collaborative communications between members of a collaboration group according to one embodiment of the invention. Assume from the earlier example that the purpose of the collaboration group 105 is to coordinate the building of a house. Here, the resource entity 112 (e.g., the owner of the house) performs a collaborative communication with the resource entity 114 (e.g., the design plans) to modify the design plans. In this example, the secret key is described as a symmetrical key, however, it is understood that alternative encryption/decryption techniques well known to those of ordinary skill in the art may have also been described.

At block 510, resource entity 114 receives a communication (e.g., via audio, video, and/or text messaging) from resource entity 112. In one embodiment, the communication includes a contact identifier (e.g., public key) and a set of one or more credentials of the resource entity 112. Here, the credentials may include permissions allowing the owner 112 to modify the design plans 114.

At block 520, the communication is decrypted with the encryption key of the resource entity 114. Because in this example a symmetrical key is used, each member of the collaboration group obtained the same secret key when added to the collaboration group, therefore, each resource entity need not have a separate public-private key pair for the purpose of decrypting a collaboration communication. Furthermore, the originator of a communication need not perform the time consuming process of encrypting a separate communication with the public key of each member to receive the communication. Rather, the original communication is encrypted with a hash function created from the secret key that is then decrypted by each group member with a copy of the same secret key.

At block 530, if the communication is authenticated based on the credentials associated with the given public key for the member, control passes to block 540. If the communication is not authenticated based on the credentials associated with the given public key for the member, control passes to block 550. Here, the resource entity 114 determines whether the resource entity 112, which is identified by its public key, may modify the design plans. Therefore, in this way, the public key of the resource entity 112 is not used here to encrypt (or decrypt) any communication, but is used for identification purposes.

Security algorithms well known to those of ordinary skill in the art may be used to authenticate the credentials. In one embodiment, the credentials (e.g., roles and responsibilities) of a specific member are delivered to another resource entity when requesting to access a collaboration resource. Here, the credentials are encrypted with the secret key and signed with the identifier (e.g., digital signature) of the sender. When the receiver receives the collaboration communication with the credentials, the receiver authenticates the credentials by matching the credentials with the signature of the sender.

For example, the collaboration communication sent from resource entity 112 to resource entity 114 may include the digital signature of resource entity 112. Therefore, resource entity 114 determines whether the credentials of resource entity 112 are authentic based on the signature of the resource entity 112. It should be understood that credentials might have more than one signature, in which case the credentials should be authenticated with the signature of each member associated with the credentials.

In one embodiment, each resource entity stores the credentials of each of the other collaboration group members. Therefore, upon receiving a request for a collaboration resource, the local resource entity may access its local copy of the credentials associated with the requestor to authenticate the request.

At block 540, the communication is authenticated and is allowed to access the resource. Here, the resource entity 112 is allowed to modify the design plans.

At block 550, the communication is denied and is not allowed to access the resource. Here, a descriptive message may be sent to the resource entity 112 explaining why the communication was denied.

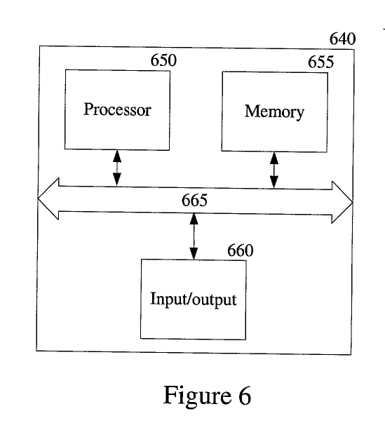

One embodiment of a computer system suitable for a relationship management system is illustrated in FIG. 6. The computer system 640 includes a processor 650, memory 655 and input/output capability 660 coupled to a system bus 665. The memory 655 is configured to store instructions which, when executed by the processor 650, perform the methods described herein. The memory 655 may also store attributes of each resource management instance created form the resource management architecture described in FIG. 2. Input/output 660 allows for the modification of the resource attributes and credentials. Input/output 660 also encompasses a receiver, a transmitter, and various types of machine-readable media, including any type of storage device that is accessible by the processor 650.

The description of FIG. 6 is intended to provide an overview of computer hardware and other operating components suitable for implementing the invention, but is not intended to limit the applicable environments. It will be appreciated that the computer system 640 is one example of many possible computer systems that have different architectures. A typical computer system will usually include at least a processor, memory, and a bus coupling the memory to the processor. One of ordinary skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

It will be appreciated that more or fewer processes may be incorporated into the method illustrated in FIGS. 3, 4, and 5 without departing from the scope of an embodiment of the invention and that no particular order is implied by the arrangement of blocks shown and described herein. It further will be appreciated that the method described in conjunction with FIGS. 3, 4, and 5 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The method may be provided as a computer program product that may include a machine-readable medium having stored thereon instructions that may be used to program a computer (or other electronic devices) to perform the method. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and a carrier wave that encodes a data signal. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

An encryption and a decryption component may be used with the computer system described in FIG. 6 to encrypt and decrypt collaboration communications. The encryption and decryption component may be implemented with either software or hardware and is well known to those of ordinary skills in the art.

In one embodiment, the resource management software application is integrated with a third party collaboration software application, such as, ICQ and AOL Instant Messenger from America Online Inc., of Dulles, Va.; Yahoo Instant Messenger from Yahoo; Inc., of Sunnyvale, Calif.; and/or Microsoft Messenger, and Microsoft NetMeeting tool from Microsoft Corp., of Redmond, Wash., each of which do not provide a resource management component, to provide a secure collaboration environment. In this way, third party collaboration software that use simple name lists (e.g., buddy lists, email address list, etc.) that do not describe the relationships between members of a collaboration group may benefit from the advantages of the resource management architecture.

It should also be understood that a contact may represent a “self” that is use to engage other resources, an acquaintance to be engaged, and a collection of resources (e.g., group). Note, that collections make a contacts definition recursive. That is, a contact may be a group comprised of groups which themselves may be comprised of groups. This allows contacts to represent complex business and social structures.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting.

What is claimed is:

1. A machine-readable medium having instructions to cause a machine to perform a method comprising:
receiving an encrypted communication from a member of a collaboration group, the communication includes a set of one or more credentials and a contact identifier associated with at least one of the set of one or more credentials;
decrypting the communication with a secret key; and
providing access to a resource based on the credentials associated with the contact identifier.

2. The machine-readable medium of claim 1 wherein the secret key is a unique encryption key used by each member of the collaboration group to provide trusted communications.

3. The machine-readable medium of claim 1 wherein the secret key is a symmetrical key shared by members of the collaboration group.

4. The machine-readable medium of claim 1 wherein the secret key is a public key portion of a public-private key pair.

5. The machine-readable medium of claim 1 wherein the secret key is a private key portion of a public-private key pair.

6. The machine-readable medium of claim 1 wherein the members of the collaboration group communicate via collaboration software.

7. A resource management system comprising:
a network;
a first resource entity being a member of a collaboration group; and
a second resource entity receiving a first communication over the network from the first resource entity, the first communication including a request to become a member of the collaboration group, receiving a second communication containing a secret key, the secret key enabling members of the collaboration group to perform trusted communications.

8. The system of claim 7 wherein the secret key is a symmetrical key.

9. The system of claim 7 wherein the secret key is a public key portion of a public-private key pair.

10. The system of claim 7 wherein the first communication comprises a set of one or more credentials describing the roles of the second resource entity within the collaboration group.

11. The system of claim 10 wherein the set of one or more credentials allow the second resource entity to delegate authority to members in the collaboration group.

12. The system of claim 7 wherein upon joining the collaboration group, the second resource entity receives a third communication from the first resource entity to access a resource controlled by the second resource entity, the third communication includes a set of one or more credentials of the first resource entity and a contact identifier of the first resource entity, the second resource entity to allow access to the resource based on the credentials of the first resource entity associated with the contact identifier.

13. The system of claim 12 wherein the third communication is decrypted with the secret key.

14. The system of claim 12 wherein the contact identifier is the public portion of a public-private key pair.

15. A resource management system comprising:
a network;
a first resource entity being a member of a collaboration group; and
a second resource entity being a member of the collaboration group, the second resource entity receiving a communication over the network from the first resource entity, the communication including a request to access a resource on the second resource entity, the communication includes a contact identifier and a set of one or more credentials, the second resource entity allows access to the resource entity based on the credentials associated with the contact identifier.

16. The system of claim 15 further comprising the second resource entity decrypting the communication from the first resource entity with a secret key.

17. The system of claim 16 wherein the secret key is a symmetrical key.

18. The system of claim 15 wherein the contact identifier is the public portion of a public-private key pair.

19. The system of claim 15 wherein the communication includes a digital signature of the first resource entity and the second resource entity authenticates the credentials of the first resource entity based on the digital signature of the first resource entity.

20. A collaboration apparatus comprising:
a means for receiving a communication from a member of a collaboration group requesting to access a resource, the communication to include a set of one or more credentials and a contact identifier associated with at least one of the set of one or more credientials;
a means for decrypting the communication based on a secret key; and
a means for allowing access to the resource based on the credentials associated with the contact identifier.

21. The apparatus of claim 20 wherein the secret key is a symmetrical key.

22. The apparatus of claim 20 wherein the members of the collaboration group each include the secret key to provide trusted communications.

23. The apparatus of claim 20 wherein the contact identifier is the public portion of a public-private key pair.

24. The apparatus of claim 20 further comprising a means to authenticate the set of credentials based on a digital signature of the member of the collaboration group requesting to access the resource, the digital signature being included in the communication.

25. The apparatus of claim 20 wherein the members of the collaboration group communication via collaboration software.

26. A collaboration apparatus comprising:
a receiver to receive a communication from a member of a collaboration group requesting to access a resource, the communication to include a set of one or more credentials and a contact identifier associated with at least one of the set of one or more credentials;
a decrypting component to decrypt the communication based on a secret key; and
a processor to allow access to the resource based on the credentials associated with the contact identifier.

27. The apparatus of claim 26 wherein the secret key is a symmetrical key.

28. The apparatus of claim 26 further comprising authenticating the set of credentials based on a digital signature of the member of the collaboration group requesting to access the resource, the digital signature being included in the communication.

29. The apparatus of claim 26 wherein the contact identifier is the public portion of a public-private key.

30. The apparatus of claim 26 wherein the members of the collaboration group communication via collaboration software.
